(19) United States
(12) Patent Application Publication
(10) Pub. No.: US 2012/0300494 A1
(43) Pub. Date: Nov. 29, 2012

(54) BACKLIGHT AND DISPLAY DEVICE

(75) Inventors: Kazufumi WATABE, Yotsukaido (JP); Masayuki Mifune, Mobara (JP); Takahiko Muneyoshi, Chiba (JP); Naohisa Andou, Mobara (JP); Mitsuhide Miyamoto, Chiba (JP)

(73) Assignee: Hitachi Displays, Ltd.

(21) Appl. No.: 13/478,171

(22) Filed: May 23, 2012

(30) Foreign Application Priority Data
May 25, 2011 (JP) 2011-116592

(51) Int. Cl. G09F 13/18; F21V 8/00

(52) U.S. Cl. 362/602; 362/613

(57) ABSTRACT

Light sources include a pair of first light sources located at both ends in an arrangement direction and a second light source located between the first light sources. Each of directions in which the first light sources face is set so as to cross a direction in which the second light source faces. Each of the first light sources has first light-emitting portions arranged along a circumferential edge and emitting lights of different colors. The second light source has second light-emitting portions arranged along the circumferential edge and emitting lights of different colors. Light emitted by one of the first light-emitting portions which is nearest to the second light-emitting portions is the same in color as light emitted by one of the second light-emitting portions which is nearest to the first light-emitting portions.

### CROSS-REFERENCE TO RELATED APPLICATION

The present application claims priority from Japanese application JP2011-116592 filed on May 25, 2011, the contents of which are hereby incorporated by reference into this application.

### BACKGROUND OF THE INVENTION

1. Field of the Invention

The present invention relates to a backlight and a display device.

2. Description of the Related Art

MEMS displays (Micro Electro Mechanical System Displays) are displays expected to be replaced with liquid crystal displays (refer to JP 2008-197668 A). The MEMS displays, which are different from those of a liquid crystal shutter system using polarized light, display brightness and darkness by mechanically opening and closing a light transmissive window with a shutter unit having a fixed opening and a shutter. Specifically, for example, light is blocked by disposing the shutter above the fixed opening while light is transmitted by retracting the shutter from above the fixed opening.

For the MEMS displays, a backlight which emits lights of three colors of red (R), green (G), and blue (B) by a field sequential system is used. Specifically, three kinds of light-emitting diodes (LEDs) which respectively emit lights of three colors of red (R), green (G), and blue (B) face the edge of a light guide plate, and the LEDs are sequentially turned on, whereby lights of red (R), green (G), and blue (B) can be emitted. These colors are mixed as an after-image because of the limit of temporal resolution of the human eye. Therefore, lights of yellow (Y), cyan (C), magenta (M), and white (W) can also be recognized. Moreover, the three kinds of light-emitting diodes are made into one package to constitute one light source, and a plurality of light sources are arranged along the edge of the backlight.

In the related art, the above-described backlight which can emit lights of a plurality of colors has a problem that an effective light-emitting region is narrowed because a region where all colors (three colors of red (R), green (G), and blue (B) in the above-described case) are mixed is narrow.

### SUMMARY OF THE INVENTION

It is an object of the invention to provide a backlight in which an effective light-emitting region where all colors are mixed is wide, and a display device including the backlight.

(1) A backlight according to the invention includes: a light guide plate having a light-emitting surface (front surface for surface light-emission); and a plurality of light sources facing an edge surface of the light guide plate and arranged along the circumferential edge of the light-emitting surface, wherein the plurality of light sources arranged along the circumferential edge of the light-emitting surface include a pair of first light sources located at both ends and at least one second light source located between the pair of first light sources, each of exiting directions (directions in which the first light sources face) of the pair of first light sources is set so as to cross an exiting direction (direction in which the second light source faces) of the at least one second light source, each of the first light sources has three or more first light-emitting portions arranged along the circumferential edge and emitting lights different from each other, the at least one second light source has three or more second light-emitting portions arranged along the circumferential edge and emitting lights different from each other, and light emitted by one of the first light-emitting portions which is nearest to the three or more second light-emitting portions is the same in color as light emitted by one of the second light-emitting portions which is nearest to the three or more first light-emitting portions. According to the invention, since light incident on the light guide plate is reflected to spread in the interior of the light guide plate, three or more different colors of lights are mixed in a region away from the light sources. In contrast to this, in a region where light is in a state just before reflection, a region where any of the colors is not mixed is generated. However, since the colors of lights of the first light-emitting portion and the second light-emitting portion which are nearest to each other are the same, the color of the second light-emitting portion which is nearest to the first light-emitting portion is different from the color of light of the first light-emitting portion which is farthest away from the second light-emitting portion. Accordingly, also in the region where light is in a state just before reflection, the light of the second light-emitting portion which is nearest to the first light-emitting portion can be mixed with the light of the first light-emitting portion having a color different from that of the second light-emitting portion. With this configuration, an effective light-emitting region can be widened.

(2) In the backlight according to (1), light emitted by one of the first light-emitting portions which is farthest away from the three or more second light-emitting portions may be the same in color as light emitted by one of the second light-emitting portions which is farthest away from the three or more first light-emitting portions.

(3) In the backlight according to (1) or (2), each of the first light sources may have three first light-emitting portions, the at least one second light source may have three second light-emitting portions, and light emitted by one of the first light-emitting portions which is located at the center may be the same in color as light emitted by one of the second light-emitting portions which is located at the center.

(4) In the backlight according to (1), light emitted by one of the first light-emitting portions which is farthest away from the three or more second light-emitting portions may be different in color from light emitted by one of the second light-emitting portions which is farthest away from the three or more first light-emitting portions.

(5) In the backlight according to (1) or (4), each of the first light sources may have three first light-emitting portions, the at least one second light source may have three second light-emitting portions, and light emitted by one of the first light-emitting portions which is located at the center may be different in color from light emitted by one of the second light-emitting portions which is located at the center.

(6) In the backlight according to any one of (1) to (5), the edge surface of the light guide plate may include a second region which the at least one second light source faces and a pair of first regions which the pair of first light sources face at both ends of the second region, and each of the pair of first regions may be inclined in a direction downward from the second region.

(7) In the backlight according to any one of (1) to (6), the edge surface of the light guide plate may be provided with concavities and convexities formed at positions facing the pair of first light sources and the at least one second light source.

(8) A display device according to the invention includes: the backlight according to any one of (1) to (7); and a display panel disposed to face the backlight.

### BRIEF DESCRIPTION OF THE DRAWINGS

FIG. 1 is a cross-sectional view schematically showing a display device according to an embodiment of the invention.

FIG. 2 shows a shutter and a drive portion thereof.

FIG. 3 is an enlarged cross-sectional view showing a light-shielding film and an opening thereof.

FIG. 4 is a plan view showing in detail a backlight according to an embodiment of the invention.

FIG. 5 explains the operation and effect of the backlight according to the embodiment.

FIG. 6 shows a modified example of a backlight according to an embodiment of the invention.

### DETAILED DESCRIPTION OF THE INVENTION

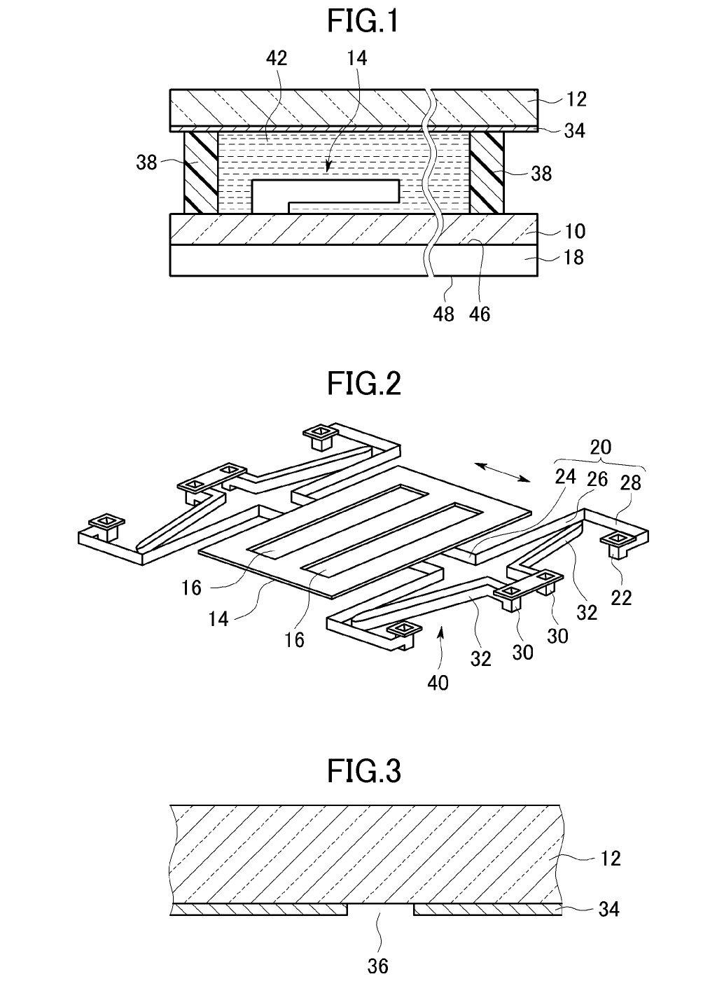

Hereinafter, embodiments of the invention will be described with reference to the drawings. FIG. 1 is a cross-sectional view schematically showing a display device according to the embodiment of the invention.

The display device has a pair of light transmissive substrates 10 and 12 (for example, glass substrates). The pair of light transmissive substrates 10 and 12 are arranged so as to face each other with a gap disposed therebetween.

One light transmissive substrate 10 (lower substrate in FIG. 1) is provided with a shutter 14 shown in FIG. 2. The shutter 14 is a plate having drive openings 16. The drive opening 16 allows light to pass therethrough while the other portions than the drive opening 16 block light. The drive opening 16 has a shape which is long in one direction. As shown in FIG. 1, light is supplied from a backlight 18 placed on the light transmissive substrate 10.

The shutter 14 is supported by first springs 20, so that the shutter 14 comes off the light transmissive substrate 10. The shutter 14 is supported by the plurality (four in FIG. 2) of first springs 20. The first spring 20 is fixed to the light transmissive substrate 10 with a first anchor portion 22.

The first spring 20, which is formed of an elastically deformable material, is disposed so as to be deformable in a direction parallel to the plate surface of the shutter 14. Specifically, the first spring 20 has a first portion 24, a second portion 26, and a third portion 28. The first portion 24 extends in a direction (direction crossing (for example, perpendicular to) the longitudinal direction of the drive opening 16) away from the shutter 14. The second portion 26 extends outwardly from the center of the drive opening 16 in its length direction, in a direction along the longitudinal direction of the drive opening 16. The third portion 28 extends in the direction (direction crossing (for example, perpendicular to) the longitudinal direction of the drive opening 16) away from the shutter 14. As shown by arrows in FIG. 2, the shutter 14 can move in the direction crossing (for example, perpendicular to) the longitudinal direction of the drive opening 16.

The light transmissive substrate 10 is provided with second springs 32 each supported by a second anchor portion 30. The second spring 32 faces the second portion 26 of the first spring 20 on the side farther away from the shutter 14 than the second portion 26. By applying a voltage to the second anchor portion 30, the second portion 26 is attracted to the second anchor portion 30 due to electrostatic attraction caused by the difference in potential between the second anchor portion 30 and the second portion 26 of the first spring 20. When the second portion 26 is attracted, the shutter 14 is also attracted via the first portion 24 which is integral with the second portion 26. That is, the first spring 20 and the second spring 32 are members for constituting a drive portion 40 for mechanically driving the shutter 14.

For the other light transmissive substrate 12, a light-shielding film 34 is formed. As shown in FIG. 3, a fixed opening 36 is formed in a portion of the light-shielding film 34, the portion being not shown in FIG. 1. When the above-described drive opening 16 of the shutter 14 is in communication with the fixed opening 36 of the light-shielding film 34, light is allowed to pass. When the fixed opening 36 of the light-shielding film 34 is shielded due to the movement of the shutter 14, light is blocked. In other words, the shutter 14 is mechanically driven so as to control the pass and blockage of light to the fixed opening 36 of the light-shielding film 34. One drive opening 16 and one fixed opening 36 corresponding to each other constitute one pixel, and an image is displayed by a large number of pixels. Therefore, a plurality (large number) of the shutters 14 are provided.

The pair of light transmissive substrates 10 and 12 are fixed with a sealing material 38 shown in FIG. 1 with a gap disposed therebetween. The sealing material 38 is in close contact with the pair of light transmissive substrates 10 and 12. Moreover, a sealed space is defined between the pair of light transmissive substrates 10 and 12 by the sealing material 38.

An oil 42 (for example, silicone oil) is filled in the sealed space. The shutter 14 and the drive portion 40 are disposed in the oil 42. Vibrations caused by the motion of the shutter 14 and the drive portion 40 can be suppressed by the oil 42. Moreover, the dielectric constant is increased by filling the oil 42, so that a drive voltage for mechanically moving the shutter 14 by electrostatic attraction can be lowered.

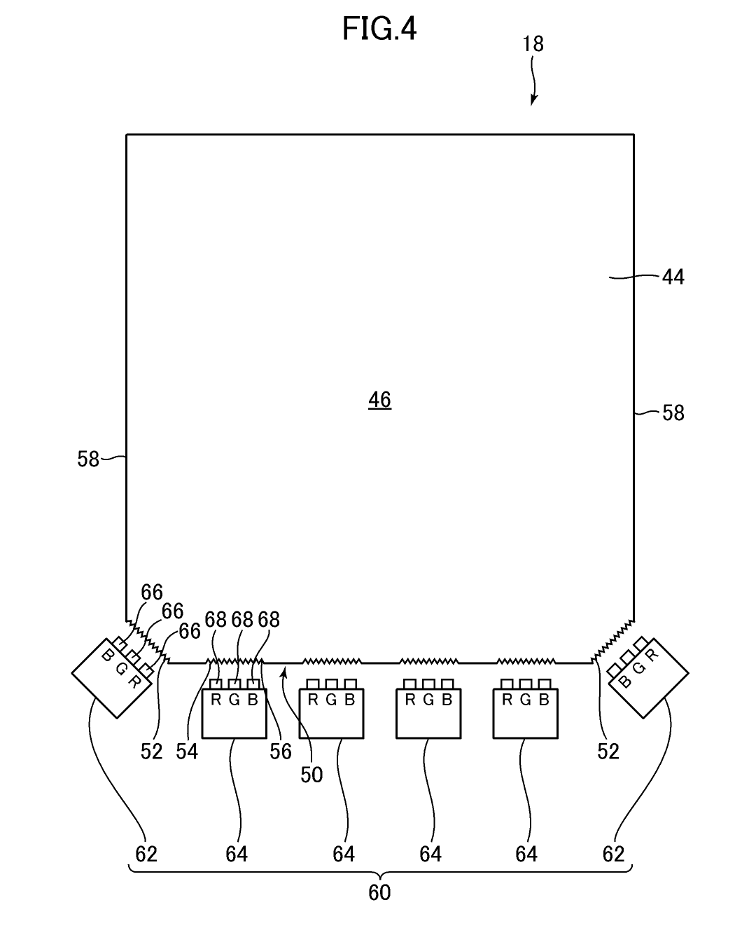

FIG. 4 is a plan view showing in detail the backlight according to the embodiment of the invention. The backlight 18 has a light guide plate 44. The light guide plate 44, which has a plate shape, has a front surface 46 (refer to FIG. 1) for surface light-emission. In a rear surface 48 (refer to FIG. 1) of the light guide plate 44, grooves (not shown) are formed so that light is reflected in the interior toward a direction of the front surface 46. Both surfaces of the light guide plate 44 in its thickness direction are the front surface 46 and the rear surface 48, respectively. A surface defining (connecting the circumferential edges of the front surface 46 and the rear surface 48) the thickness of the light guide plate 44 is an edge surface 50 of the light guide plate 44. Light is incident on the edge surface 50 of the light guide plate 44.

The edge surface 50 of the light guide plate 44 includes a pair of first regions 52 on which light is incident. The pair of first regions 52 are located at an interval. Moreover, the edge surface 50 of the light guide plate 44 includes, between the pair of first regions 52, a second region 54 on which another light is incident. Each of the pair of first regions 52 is inclined in a direction downward from the second region 54. That is, the first region 52 is a region corresponding to a position where the corner of the light guide plate 44 having a rectangle shape is chamfered. In the first regions 52 and the second region 54, concavities and convexities (for example, grooves 56 such as V-grooves) for radially spreading the incident light are formed.

The edge surface 50 of the light guide plate 44 includes side surfaces 58 each extending from the side of the first region 52 opposite to the second region 54 in a direction away from the second region 54. The side surface 58 is configured so that light is reflected in the interior to return to the interior. The pair of side surfaces 58 face in opposite directions to each other.

The backlight 18 has a plurality of light sources 60 arranged to face the edge surface 50 of the light guide plate 44. The plurality of light sources 60 include a pair of first light sources 62 located at both ends in the arrangement direction and one or a plurality of second light sources 64 located between the pair of first light sources 62. The first light source 62 faces the first region 52, and the second light source 64 faces the second region 54. Each of directions (directions in which lights exit) in which the pair of first light sources 62 face is set so as to cross a direction (direction in which light exits) in which the second light source 64 faces. Each of the pair of first light sources 62 is directed obliquely to the central direction of the front surface 46 of the light guide plate 44.

The first light source 62 has three or more (three in the example of FIG. 4) first light-emitting portions 66. These first light-emitting portions 66, which are arranged along the circumferential edge of the front surface 46 of the light guide plate 44, emit lights of three or more different colors. In the example of FIG. 4, the first light-emitting portions 66 emit lights of three colors of red (R), green (G), and blue (B).

The second light source 64 has three or more (three in the example of FIG. 4) second light-emitting portions 68. These second light-emitting portions 68, which are arranged along the circumferential edge of the front surface 46 of the light guide plate 44, emit lights of three or more different colors. In the example of FIG. 4, the second light-emitting portions 68 emit lights of three colors of red (R), green (G), and blue (B). The three or more colors of lights of the second light-emitting portions 68 are the same as the three or more colors of lights of the first light-emitting portions 66.

In the embodiment, the color of light emitted by the first light-emitting portion 66 which is located nearest to the second light-emitting portion 68, among the plurality of first light-emitting portions 66, is the same (red (R) in FIG. 4) as the color of light emitted by the second light-emitting portion 68 which is located nearest to the first light-emitting portion 66, among the plurality of second light-emitting portions 68. Moreover, the color of light emitted by the first light-emitting portion 66 which is located farthest away from the second light-emitting portion 68, among the plurality of first light-emitting portions 66, is the same (blue (B) in FIG. 4) as the color of light emitted by the second light-emitting portion 68 which is located farthest away from the first light-emitting portion 66, among the plurality of second light-emitting portions 68.

In FIG. 4, the first light source 62 has three first light-emitting portions 66. The second light source 64 has three second light-emitting portions 68. The color of light emitted by the first light-emitting portion 66 which is located at the center is the same (green (G) in FIG. 4) as the color of light emitted by the second light-emitting portion 68 which is located at the center.

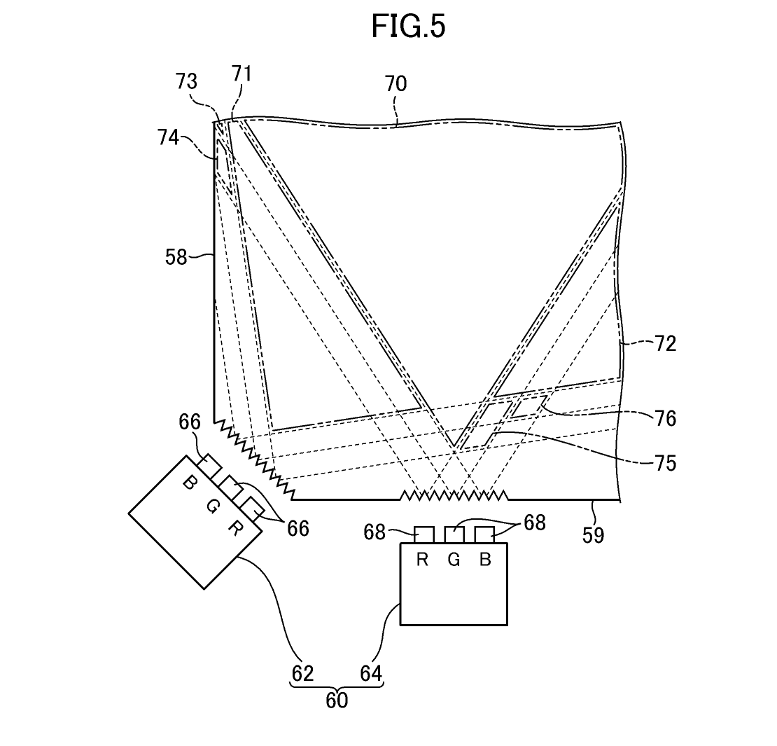

FIG. 5 explains the operation and effect of the backlight according to the embodiment. Each of lights exiting from the first light-emitting portions 66 and the second light-emitting portions 68 of the first light source 62 and the second light source 64 is incident on the light guide plate 44. Since the light incident on the light guide plate 44 is reflected to spread in the interior of the light guide plate 44, different colors of lights are mixed in a region away from the light sources 60. A region where three colors of red (R), green (G), and blue (B) are mixed is recognized as a white light region. In the embodiment, even if any of the colors of red (R), green (G), and blue (B) is intense, the light color where the three colors are mixed is defined as white.

In the related-art example, since there is no first light source 62, a white region 70 is formed due to the lights from the second light-emitting portions 68 of the second light source 64, that is, a mixed color of red (R), green (G), and blue (B). In this case, the white region is narrowed because the mixed color region of the three colors is very narrow. In the embodiment, however, white regions 71 and 72 caused by the first light source 62 are added by the addition of the first light source 62, making it possible to further extend a white region.

Moreover, due to the lights of the second light-emitting portions 68, in a region where light is in a state just before reflection by the side surface 58 of the light guide plate 44, two non-white regions, a non-white region 73 and a non-white region 74, are generated. In the non-white region 73, red (R) and green (G) are mixed together but blue (B) is not mixed. In the non-white region 74, only red (R) is present and blue (B) and green (G) are not mixed. In the embodiment, since the colors (R) of lights of the first light-emitting portion 66 and the second light-emitting portion 68 which are nearest to each other are the same, the color (R) of the second light-emitting portion 68 which is nearest to the first light-emitting portion 66 is different from the color (B) of light of the first light-emitting portion 66 which is farthest away from the second light-emitting portion 68. Therefore, by disposing the first light source 62 as in the embodiment, as for the lights from the second light-emitting portions 68, the color blue (B) of the first light-emitting portion 66 can be mixed for the non-white region 73 where red (R) and green (G) are mixed together but blue (B) is not mixed within the light guide plate, to make the non-white region 73 into a white region. Similarly, the blue (B) and green (G) of the first light-emitting portions 66 can be mixed for the region 74 where only red (R) is present and blue (B) and green (G) are not mixed, to make the non-white region 74 into a white region.

Further, in a region where lights from the second light source 64 are mixed on the side of a side surface 59 of the light guide plate 44, two non-white regions are generated. In one of the regions, blue (B) and green (G) are mixed together but red (R) is not mixed. In the other region, only blue (B) is present and red (R) and green (G) are not mixed. In the embodiment, since the colors (R) of lights of the first light-emitting portion 66 and the second light-emitting portion 68 which are nearest to each other are the same, the color (R) of the second light-emitting portion 68 which is nearest to the first light-emitting portion 66 is different from the color (B) of light of the first light-emitting portion 66 which is farthest away from the second light-emitting portion 68. Therefore, by disposing the first light source 62 as in the embodiment, the color red (R) of the first light-emitting portion 66 can be mixed for the non-white region where blue (B) and green (G) are mixed together but red (R) is not mixed, and therefore, a white region 75 can be obtained. Moreover, the red (R) and green (G) of the first light-emitting portions 66 can be mixed for the region where only blue (B) is present and red (R) and green (G) are not mixed, to obtain a white region 76. According to the embodiment, a white region can be further widened.

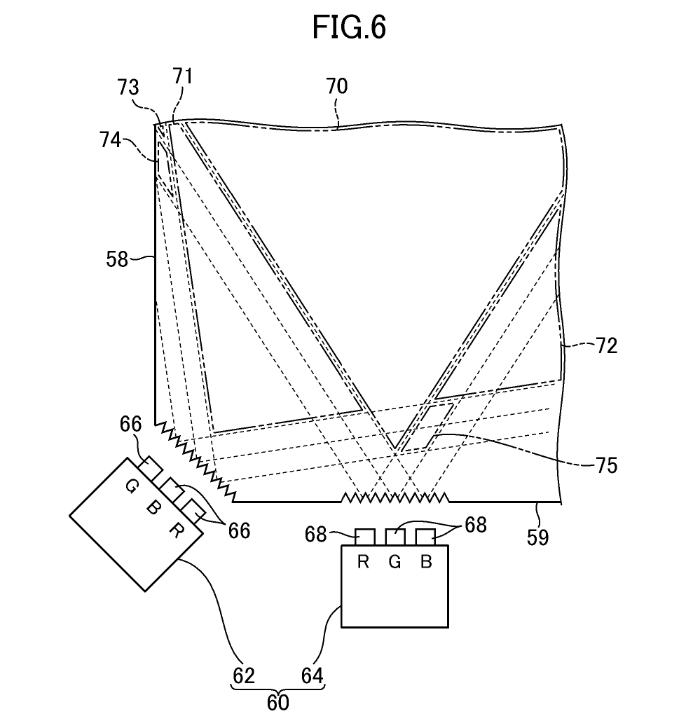

FIG. 6 shows a modified example of a backlight according to the embodiment of the invention. In this example, light (G) emitted by the first light-emitting portion 66 which is farthest away from the second light-emitting portion 68 is different in color from light (B) emitted by the second light-emitting portion 68 which is farthest away from the first light-emitting portion 66. Light (B) emitted by the first light-emitting portion 66 which is located at the center is different in color from light (G) emitted by the second light-emitting portion 68 which is located at the center. The other configurations correspond to the contents described in the above embodiment.

In the related-art example, there is no first light source 62. Therefore, although the white region 70 is formed due to the lights from the second light-emitting portions 68 of the second light source 64, that is, a mixed color of red (R), green (G), and blue (B), the white region is narrowed because the mixed color region of the three colors is narrow. However, the white regions 71 and 72 caused by the first light source 62 are added by the addition of the first light source 62, making it possible to further extend a white region, also in the embodiment.

Moreover, due to the lights of the second light-emitting portions 68, in a region where light is in a state just before reflection by the side surface 58 of the light guide plate 44, two non-white regions, the non-white region 73 and the non-white region 74, are generated. In the non-white region 73, red (R) and green (G) are mixed together but blue (B) is not mixed. In the non-white region 74, only red (R) is present and blue (B) and green (G) are not mixed. Therefore, by disposing the first light source 62 like the embodiment, as for the lights from the second light-emitting portions 68, the color blue (B) of the first light-emitting portion 66 can be mixed for the non-white region 73 where red (R) and green (G) are mixed together but blue (B) is not mixed within the light guide plate, to make the non-white region 73 into a white region. Similarly, the green (G) and blue (B) of the first light-emitting portions 66 can be mixed for the region 74 where only red (R) is present and blue (B) and green (G) are not mixed, to make the non-white region 74 into a white region.

Further, in a region where the lights from the second light source 64 are mixed on the side of the side surface 59 of the light guide plate 44, two non-white regions are generated. In one of the regions, blue (B) and green (G) are mixed together but red (R) is not mixed. In the other region, only blue (B) is present and red (R) and green (G) are not mixed. By disposing the first light source as in the embodiment, the color red (R) of the first light-emitting portion 66 can be mixed for one of the two non-white regions where blue (B) and green (G) are mixed together but red (R) is not mixed, and therefore, the white region 75 can be obtained. According to the embodiment, a white region can be further widened.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A backlight comprising:
a light guide plate having a light-emitting surface; and
a plurality of light sources facing an edge surface of the light guide plate and arranged along the circumferential edge of the light-emitting surface, wherein
the plurality of light sources arranged along the circumferential edge of the light-emitting surface include a pair of first light sources located at both ends and at least one second light source located between the pair of first light sources,
each of exiting directions of the pair of first light sources is set so as to cross an exiting direction of the at least one second light source,
each of the first light sources has three or more first light-emitting portions arranged along the circumferential edge and emitting lights different from each other,
the at least one second light source has three or more second light-emitting portions arranged along the circumferential edge and emitting lights different from each other, and
light emitted by one of the first light-emitting portions which is nearest to the three or more second light-emitting portions is the same in color as light emitted by one of the second light-emitting portions which is nearest to the three or more first light-emitting portions.

2. The backlight according to claim 1, wherein
light emitted by one of the first light-emitting portions which is farthest away from the three or more second light-emitting portions is the same in color as light emitted by one of the second light-emitting portions which is farthest away from the three or more first light-emitting portions.

3. The backlight according to claim 1, wherein
each of the first light sources has three first light-emitting portions,
the at least one second light source has three second light-emitting portions, and
light emitted by one of the first light-emitting portions which is located at the center is the same in color as light emitted by one of the second light-emitting portions which is located at the center.

4. The backlight according to claim 1, wherein
light emitted by one of the first light-emitting portions which is farthest away from the three or more second light-emitting portions is different in color from light emitted by one of the second light-emitting portions which is farthest away from the three or more first light-emitting portions.

5. The backlight according to claim 1, wherein
each of the first light sources has three first light-emitting portions,
the at least one second light source has three second light-emitting portions, and
light emitted by one of the first light-emitting portions which is located at the center is different in color from light emitted by one of the second light-emitting portions which is located at the center.

6. The backlight according to claim 1, wherein
the edge surface of the light guide plate includes a second region which the at least one second light source faces and a pair of first regions which the pair of first light sources face at both ends of the second region, and
each of the pair of first regions is inclined in a direction downward from the second region.

7. The backlight according to claim 1, wherein
the edge surface of the light guide plate is provided with concavities and convexities formed at positions facing the pair of first light sources and the at least one second light source.

8. The backlight according to claim 1, wherein
the backlight is driven by a field sequential system.

9. A display device comprising:
the backlight according to claim 1; and
a display panel disposed to face the backlight.

10. The display device according to claim 9, wherein
the display panel includes a plurality of light shutters each of which controls the transmission and blockage of light exiting from the light-emitting surface.
